(19) United States
(12) Patent Application Publication
(10) Pub. No.: US 2022/0364943 A1
(43) Pub. Date: Nov. 17, 2022

(54) DISTRIBUTED PRESSURE SENSING USING FIBER-OPTIC DISTRIBUTED ACOUSTIC SENSOR AND DISTRIBUTED TEMPERATURE SENSOR

(71) Applicant: Board of Supervisors of Louisiana State University and Agricultural and Mechanical College, Baton Rouge, LA (US)

(72) Inventors: Jyotsna Sharma, Baton Rouge, LA (US); Gerald Kelechi Ekechkwu, Baton Rouge, LA (US)

(21) Appl. No.: 17/746,315

(22) Filed: May 17, 2022

Related U.S. Application Data
(60) Provisional application No. 63/189,533, filed on May 17, 2021.

(51) Int. Cl. G01L 11/02; G01K 11/32; G01H 9/00; G01L 1/24; G06N 5/00

(52) U.S. Cl. CPC G01L 11/025; G01K 11/32; G01H 9/004; G01L 1/242; G06N 5/003

(57) ABSTRACT

A machine learning system and method are provided for using fiber-optic Distributed Acoustic Sensor (DAS) and Distributed Temperature Sensor (DTS) data to predict pressure along one or more optical fiber cables. DAS and DTS data are used to train a model to predict pressure based on the DAS and DTS data corresponding to optical signals carried on the fiber cable(s). The trained model is then used to process acquired DAS and DTS data corresponding to optical signals carried on the fiber cable(s) to the predict pressure distributed along the cable(s).

### CROSS-REFERENCE TO RELATED APPLICATION

This application claims priority to co-pending U.S. provisional application entitled, “Distributed Pressure Sensing Using Fiber-Optic Distributed Acoustic Sensor and Distributed Temperature Sensor,” having Ser. No. 63/189,533, filed May 17, 2021, which is entirely incorporated herein by reference.

### TECHNICAL FIELD

The present disclosure is related to distributed pressure sensing using fiber-optic distributed acoustic sensor and distributed temperature sensor.

### BACKGROUND

Prediction of downhole pressures plays a vital role in a variety of applications including the management and evaluation of petroleum, geothermal, and groundwater resources. Traditionally, pressure is measured using gauges. While offering a cost-effective measurement solution, pressure gauges suffer from many limitations, such as frequent calibration needs, low tolerance in harsh environments (such as high-temperature, high-pressure, corrosive conditions, characteristic of petroleum and geothermal reservoirs), hysteresis errors, and ability to only provide pressure at the discrete gauge location (in other words, single-point sensing).

Distributed fiber optics sensing (DFOS) is a non-invasive, real-time sensing technology that can overcome many limitations of the traditional gauges. Among other things, fiber optic sensors are insensitive to electromagnetic interference, resistant to corrosion and high pressure and high temperature conditions and do not require any electronics along the optical path, making them suitable for many downhole sensing applications. The optical fiber functions both as the sensor and the channel to transmit the data, providing a truly distributed measurement simultaneously along the entire cable. These sensors are capable of measuring physical properties such as temperature (via Distributed Temperature Sensing or DTS), vibration (via Distributed Acoustic Sensing or DAS), and strain (via Distributed Strain Sensing or DSS), simultaneously along the entire fiber.

Although DAS and DTS have been used for a variety of applications, ranging from flow profiling, fracture monitoring, seismic measurement, leak detection and others, real-time distributed pressure measurement in high-pressure well-scale conditions remains a challenging problem.

### SUMMARY

The present disclosure is directed to a machine learning (ML) system and method for predicting distributed pressure based at least in part on distributed acoustic sensing (DAS) and distributed temperature sensing (DTS) data. The ML system comprises a processor and a memory device. The processor is configured to perform a ML pressure prediction algorithm that performs a process comprising:
using DAS and DTS data acquired from optical signals carried on one or more optical fiber cables to train a model to predict pressure based on the acquired DAS and DTS data;
after the model has been trained, acquiring post-model-training DAS and DTS data from optical signals carried on said one or more optical fiber cables; and
using the model to process the acquired post-model-training DAS and DTS data to predict pressure distributed along said one or more optical fiber cables based at least in part on acquired post-model-training DAS and DTS data.

In accordance with a representative embodiment of the system, the DAS data used to train the model and the DAS data used by the model to predict pressure is low-frequency (LF) DAS data.

In accordance with a representative embodiment of the system, the LF DAS data corresponds to DAS frequency components less than or equal to 2 Hertz (Hz) in frequency.

The ML method comprises:

using DAS and DTS data acquired from optical signals carried on one or more optical fiber cables to training a model to predict pressure based on the acquired DAS and DTS data;

after the model has been trained, acquiring post-model-training DAS and DTS data from optical signals carried on said one or more optical fiber cables; and

using the model to process the acquired post-model-training DAS and DTS data to predict pressure based at least in part on acquired post-model-training DAS and DTS data.

In accordance with a representative embodiment of the method, the DAS data used to train the model and the DAS data used by the model to predict pressure is low-frequency (LF) DAS data.

In accordance with a representative embodiment of the method, the LF DAS data corresponds to DAS frequency components less than or equal to 2 Hertz (Hz) in frequency.

The ML algorithm can be implemented as a software computer program for execution by one or more processors for predicting distributed pressure based at least in part on DAS and DTS data. The ML computer program is embodied on a non-transitory computer-readable medium and comprises:
instructions for processing DAS and DTS data acquired corresponding to optical signals carried on one or more optical fiber cables to train a model to predict pressure based on the acquired DAS and DTS data; and
instructions for using the trained model to process DAS and DTS data acquired after the model has been trained to predict pressure based at least in part on acquired post-model-training DAS and DTS data.

In accordance with a representative embodiment of the computer program, the DAS data used to train the model and the DAS data used by the model to predict pressure is low-frequency (LF) DAS data.

In accordance with a representative embodiment of the computer program, the LF DAS data corresponds to DAS frequency components less than or equal to 2 Hertz (Hz) in frequency.

These and other features and advantages of the inventive principles and concepts will become apparent from the following description, drawings and claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. It is to be understood that in some instances, various aspects of the invention may be shown exaggerated or enlarged to facilitate an understanding of the invention.

The patent or application file contains at least one drawing executed in color. Copies of this patent or patent application with color drawing(s) will be provided by the Office upon request and payment of the necessary fee.

FIG. 1 graphically illustrates the backscattered light spectrum generated from typical DFOS.

FIG. 2 is a Test-well schematic diagram showing the location of four downhole gauges and fiber-optic DAS and DTS sensors of an experimental set-up used to demonstrate the inventive principles and concepts.

FIG. 3 shows a table that summarizes the data acquisition parameters and sensor specifications for the set-up shown in FIG. 2.

FIG. 4 shows a table that summaries the two datasets acquired by the set-up shown in FIG. 2 in terms of different gas injection volumes, water circulation rates, backpressure, and injection method.

FIGS. 5A-5D and FIGS. 6A-6D show the DAS waterfall plots for Bands-LF, 0, 1, and 2 for Dataset-1 and Dataset-2, respectively, which indicate the gas flow signature in water which is observed more clearly in Dataset-1 (with no water circulation) as compared to Dataset-2 (with water circulation); FIGS. 5A-5D correspond to, respectively, Bands-LF, 0, 1 and 2. FIGS. 6A-6D correspond to, respectively, Bands-LF, 0, 1 and 2.

FIGS. 7A-7B and FIGS. 8A-8B show the pressure and temperature profiles for Dataset-1 and Dataset-2, respectively, at the four depths where the gauges are installed (487 ft., 2023 ft., 3502 ft., and 5025 ft.) in the set-up shown in FIG. 2.

FIG. 9 is a flow diagram depicting the analysis workflow in accordance with a representative embodiment for training and using the model to predict distributed pressure.

FIG. 10 is a flow diagram of the random forest algorithm that can be used to train the model

FIG. 11 shows Table 3, which summarizes the input and output features used for the ML models for the single-depth and distributed pressure modeling steps.

FIGS. 12A-12C and 13A-13C show the cross-plots between DAS and DTS for the DAS frequency Bands-LF, 0, and 1 for Dataset-1 and Dataset-2, respectively.

FIGS. 14A-14C and 15A-15C show the cross-plots between DAS and pressure at various depths for Datasets-1 and Dataset-2, respectively.

FIGS. 16A-16D show the RMSE and R² values for the pressure predictions of the testing sets of Dataset-1 at the four gauge locations for the seven DAS frequency bands.

FIGS. 17A-17L show the predicted and the actual pressure profiles for the testing subsample for Dataset-1 for Bands-LF, 0, and 1 at the four gauge locations.

FIGS. 18A-18D show the results from single-depth pressure prediction for Dataset-2 across the four gauge depths for the testing subsample.

FIGS. 19A-19L show the predicted and the actual pressure profiles for the testing subsample for Dataset-2 for Bands-LF, 0, and 1 at the four gauge locations; FIGS. 19A-19L compare the predicted and the actual pressure trends for the testing subsample for Dataset-2.

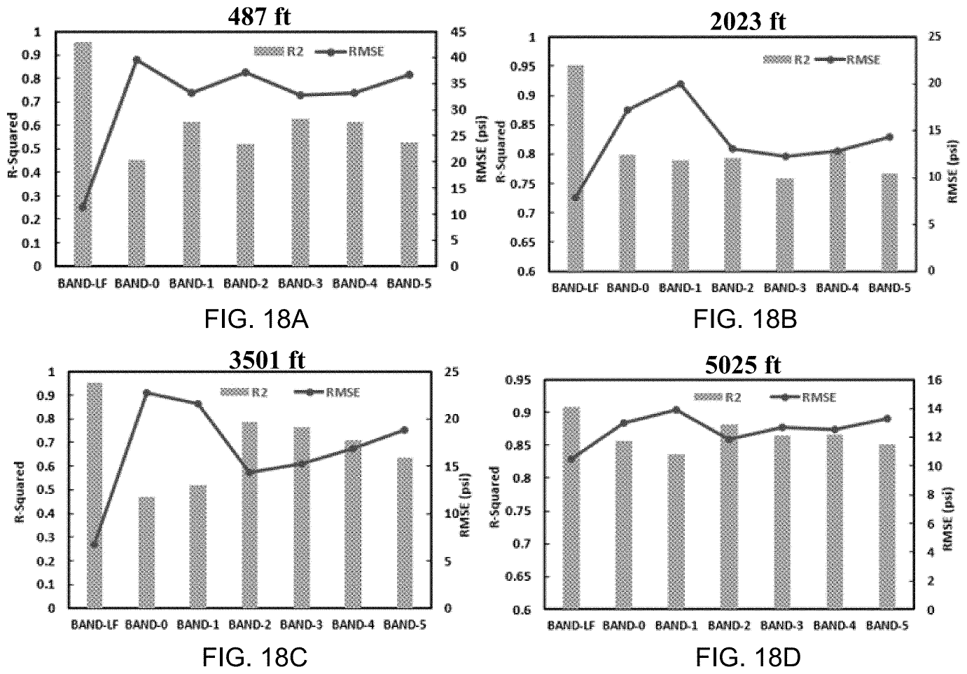

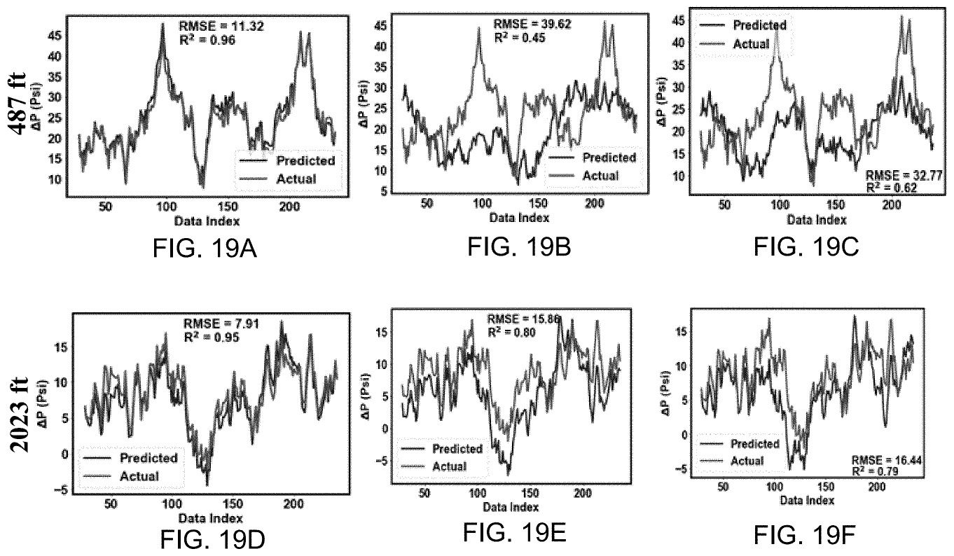

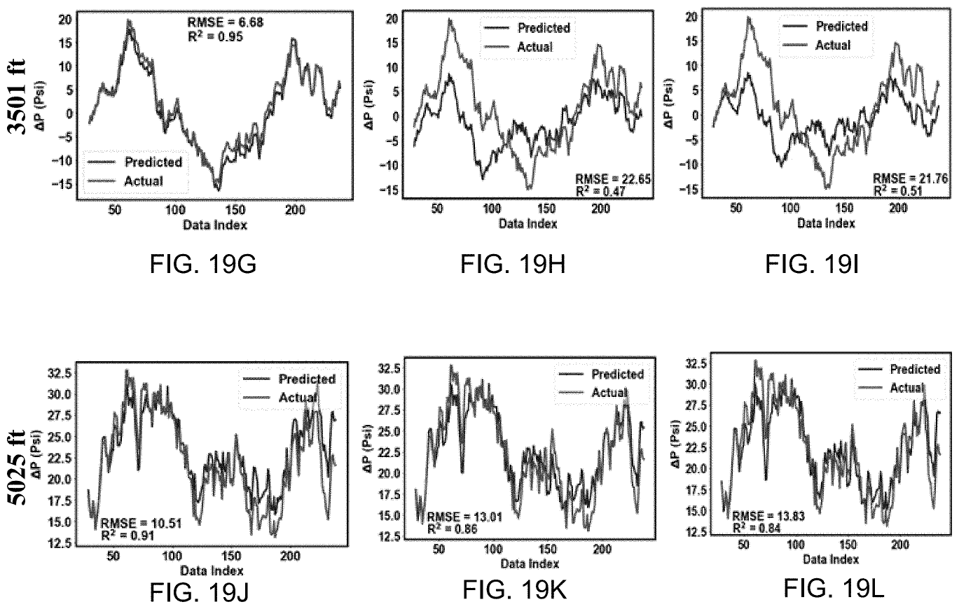

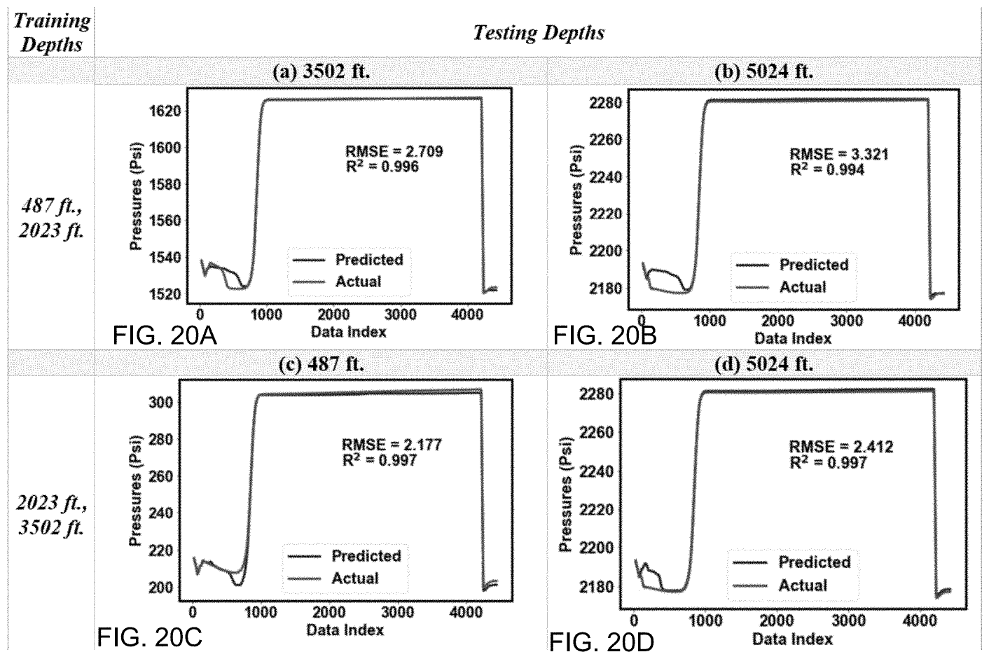

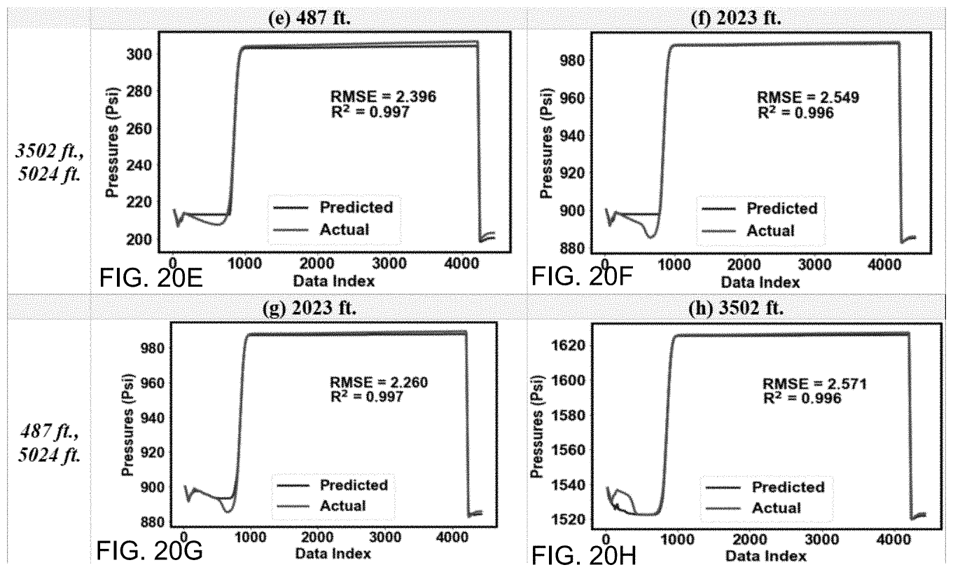

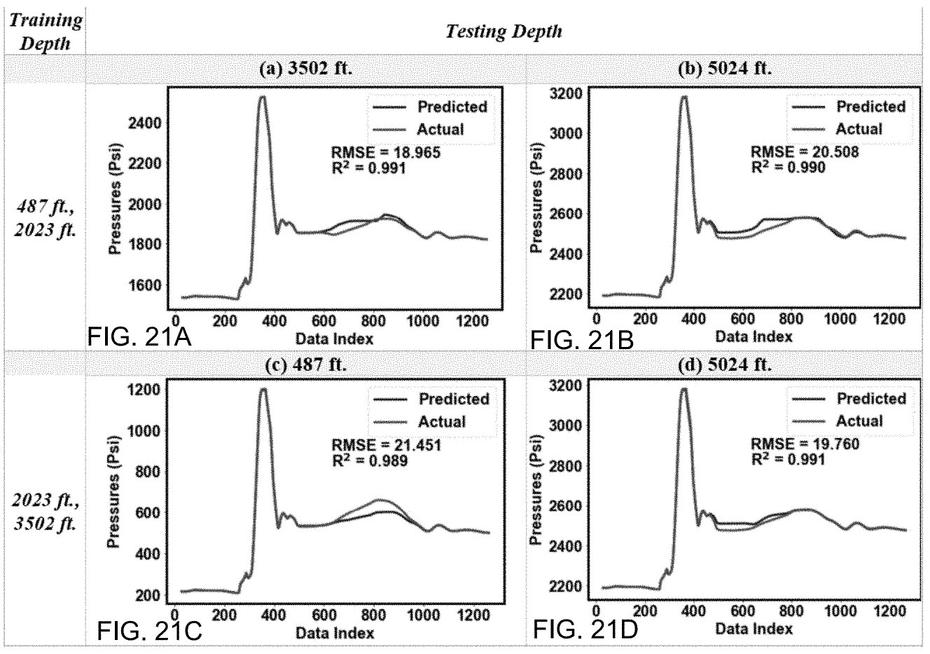

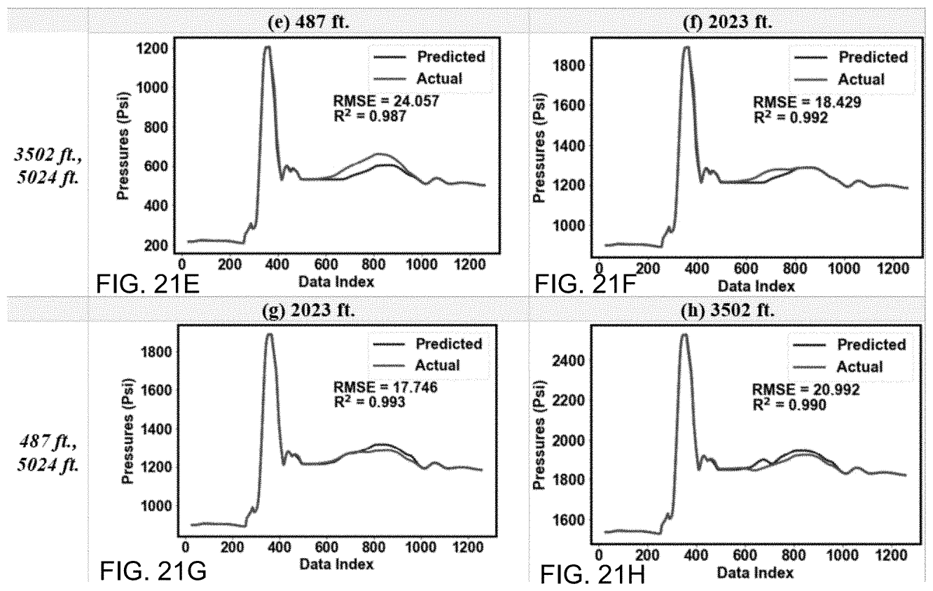

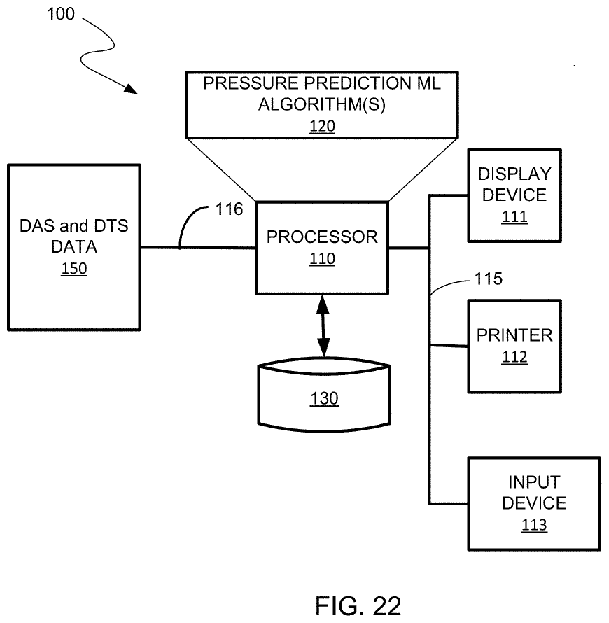

FIGS. 18A-19L clearly demonstrate that the random forest model using low-frequency DAS as input gives a more accurate prediction of pressure.

FIGS. 20A-20H and 21A-21H show the predicted versus the actual pressure plots for eight different scenarios, for Dataset-1 and Datset-2, respectively.

FIG. 22 illustrates a block diagram of an ML computer system in accordance with a representative embodiment that can be used to acquire DAS and DTS data, to use the acquired DAS and DTS data to train the model and to use the trained model to process acquired DAS and DTS data to perform pressure prediction.

### DETAILED DESCRIPTION

The present disclosure discloses representative, or exemplary, embodiments of a machine learning system and method that use fiber-optic Distributed Acoustic Sensor (DAS) and Distributed Temperature Sensor (DTS) data to estimate pressure along the fiber. The present disclosure presents and demonstrates a machine learning assisted workflow for continuous real-time distributed measurement of pressure using the DAS and DTS data. The machine learning system and method use fiber-optic DAS and DTS data to predict pressure along one or more optical fiber cables. DAS and DTS data are first acquired and used to train a model to predict pressure distributed along the fiber cable(s) based on the DAS and DTS data corresponding to optical signals carried on the fiber cable(s). The trained model is then used to process acquired DAS and DTS data corresponding to optical signals carried on the fiber cable(s) to the predict pressure distributed along the cable(s).

In the present disclosure, the method and system are demonstrated using datasets from high-pressure flow experiments conducted in a 5163-ft deep well, but it will be understood that the system and method are not limited to being used for any particular application or environment. For these experiments, the workflow utilizes the random forest algorithm and involves a two-step process for distributed pressure estimation. It should be noted that the workflow can also be implemented using other machine learning algorithms. First, single-depth predictive modeling is performed to explore the relationship between the DAS (in seven different frequency bands), DTS, and the gauge pressures at the four downhole locations (in the wellbore). The single-depth analysis showed that the low-frequency component (<2 Hz) of DAS, when combined with the DTS data, consistently outperform higher frequency DAS in pressure prediction with the average coefficient of determination over 0.96. This may be attributed to the unique property of low-frequency DAS sensitivity to strain and temperature. In the second step, the DTS and the low-frequency DAS data from two gauge locations were used to predict pressures at different depths, demonstrating the distributed pressure measurement capability.

A majority of the known DAS applications rely on the higher frequency components. The study presented in the present disclosure presents a novel application of low-frequency DAS combined with DTS for distributed pressure measurement at well-scale conditions.

In the following detailed description, for purposes of explanation and not limitation, exemplary, or representative, embodiments disclosing specific details are set forth in order to provide a thorough understanding of an embodiment according to the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers. A “processor” can also mean one or more hardware processors that perform an algorithm solely in hardware, such as in one or more state machines implemented in logical or programmable gate arrays, for example.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

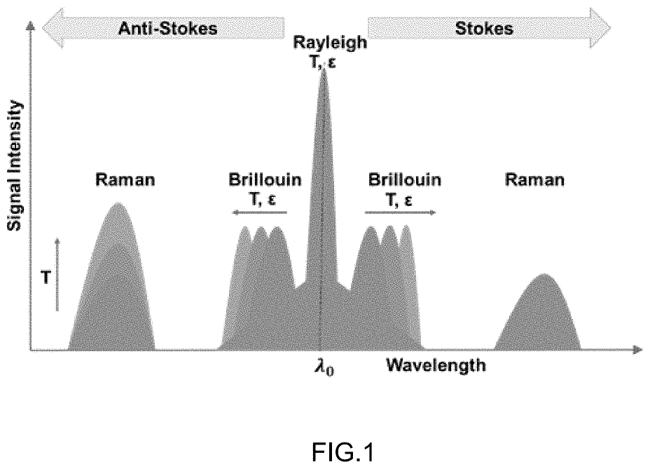

FIG. 1 graphically illustrates the backscattered light spectrum generated from typical DFOS. DFOS utilizes the optical time-domain reflectometry (OTDR) principle to measure the spatial distribution of an intended measurand. In the OTDR method, successive short laser pulses are sent out of the transmitter into the fiber, causing interactions with the heterogeneous crystalline core of the fiber optic cable. The core acts as scattering sites sending the backscattered light or signals back to the interrogation unit located at the surface. These impurities or molecular level heterogeneities are inherently and unintentionally produced during the optical fiber manufacturing. The interactions between the light and the scattering sites along the core of the fiber sense the temperature, vibration, and strain variation originating from events in the vicinity of the fiber-optic cable. The spectrum of the backscattered light consists of the Rayleigh, Brillouin, and Raman components (FIG. 1). Typically, the DTS uses the backscattered Raman component to measure temperature, DAS uses the backscattered Raleigh component to measure vibrations, while DSS uses the Brillouin component to measure strain.

Acoustic disturbance on a fiber generates microscopic elongation or compression of the fiber (micro-strain), which causes a change in the phase relation and/or amplitude. The raw DAS data are usually delivered in the form of delays in the optical phase [−π to +π] between two points along the fiber cable. The phase delay varies linearly with a small length change (the axial strain) between two locations separated by the gauge length. Differences in the strain obtained during successive pulses or the time differential of the measured optical phase (i.e., strain rate) may also be provided as a signal response by some sensing unit providers.

A majority of the known DAS applications have focused on the high-frequency bands (>2 Hz) of the DAS data. The use of low-frequency DAS in the oil and gas industry is very recent and only a few researchers have explored it for practical applications. For instance, it is known to use low-frequency DAS data (<0.05 Hz) to constrain the length, density, and width of reservoir fractures. It is also known to employ a low-frequency DAS system to detect strain at mHz frequencies. Low-frequency DAS has also been used for the acquisition of S-wave profiles. A unique characteristic of low-frequency DAS is that it is sensitive to both temperature and strain effects, and thus the dynamic strain rates are clearly observed. Thus, in principle, the low-frequency DAS phase data (<1 Hz) has a more direct relationship with pressure, which is also demonstrated in the workflow presented below in this disclosure.

### Theoretical Background

When light travels through a fiber of length L and refractive index n, the optical phase Ø is related to the wavenumber k by the following expression:

Ø=nkL, where k=2π/λ (1)

Direct pressure exposure induces changes in a phase differential dØ/Ø which changes the properties of the optical fiber. The changes in the optical phase induce strain (dL/L or ε_{zg}), which modifies the index of refraction (dn/n) of the material (the photo-elasticity effect), and causes waveguide dispersion (dk/k) as shown below:

dØ/Ø=dL/L+dn/n+dk/k (2)

The third term representing waveguide mode dispersion effects is negligible. The phase delay induces strain as shown below with dn/n now represented by the second term of the left side of the equation below.

$$\frac{d ϕ}{ϕ} = {ε}_{zg} - \frac{{n}^{2}}{2} [ ( {P}_{11} - {P}_{12} ) {ε}_{rg} + {P}_{12} {ε}_{zg} ] \qquad ( 3 )$$

where Pᵢⱼ is the strain optic (elastooptic or Pockels) coefficients and ε_{zg} and ε_{rg} are the axial and the radial components of the induced strain in the fiber, respectively. Accounting for double transit, substituting Eqn 1 into Eqn 3 and rearranging the equation, the strain sensitivity is given as:

$${ε}_{zg} = λ d ϕ / 2 π nL ξ \qquad ( 4 )$$

$$where , ξ = 1 - \frac{{n}^{2}}{2} [ {P}_{12} - {v}_{g} ( {P}_{11} + {P}_{12} ) ] \qquad ( 5 )$$

Eqn (4) above shows the relationship between the pressure-induced strain and the phase differential. An expression for pressure sensitivity due to the induced strain is as follows:

$${ε}_{zg} / p = - \frac{1 - 2 ( 1 - f ) {v}_{p} - 2 {fv}_{g}}{{fE}_{g} + ( 1 - f ) {E}_{p}} \qquad ( 6 )$$

The expression has been deemed accurate for f=(a/b)²<<1 and Eₚ<<E_{g}, where, a is the radius of the fiber, b is the radius of the coating, E_{g} and v_{g} are the Young's modulus and the Poisson ratio of the glass, respectively, while Eₚ and vₚ are the Young's modulus and the Poisson ratio of the cladding, respectively. It has been shown that the sensitivity is generally governed by both the bulk and the Young's moduli of the coating materials, which are also temperature dependent. Furthermore, it has been observed that the pressure sensitivity of coated fibers can be frequency-dependent and this dependency is affected by the combined or synergistic effects of all the coatings and the fiber cable.

DAS measurements based on Rayleigh backscattering are temperature and strain dependent. However, the way it affects the measurement is different for both strain and temperature. The strain affects the measurement by directly changing the actual fiber length, but also through changes of the refractive index (photo-elastic effect). The temperature affects the measurement, again through changes of the fiber length (thermal expansion), but also through changes of the refractive index (thermo-optic effect). So at all times, the DAS measurement is affected by both strain and temperature. However thermal changes typically have a response time much slower than strain changes, and hence will have a much lower frequency content. The relationship between low-frequency DAS (LFDAS) and temperature and strain variations can be presented as follows:

LFDAS=C₁Δε+C₂ΔT (7)

where, Δε and ΔT are the strain and the temperature variations, respectively, and C₁ and C₂ are coefficients dependent on the fiber structure and material properties. C₂ can be significantly dependent on the thermal expansion coefficients of the entire multilayer structure of the fiber which could vary from fiber-to-fiber.

The above discussion establishes the physical dependencies that exist between the pressure perturbations and the DAS-based measurements. However, the above equations also highlight the complex and often non-linear relations that depend on the material properties (such as, thickness, elasticity, strain optic coefficients, etc.) and the dynamic environmental conditions (such as temperature and frequency effects), which may not be fully known without assumptions or limitations. Machine learning algorithms have been demonstrated to effectively “learn” the complex non-linear relationships between a given set of target prediction output and input features. Thus, a machine learning approach was adopted in this study to directly learn the relationship between pressure and the DAS and DTS measurements using the observed data.

### Data Acquisition

### Experimental Set-Up

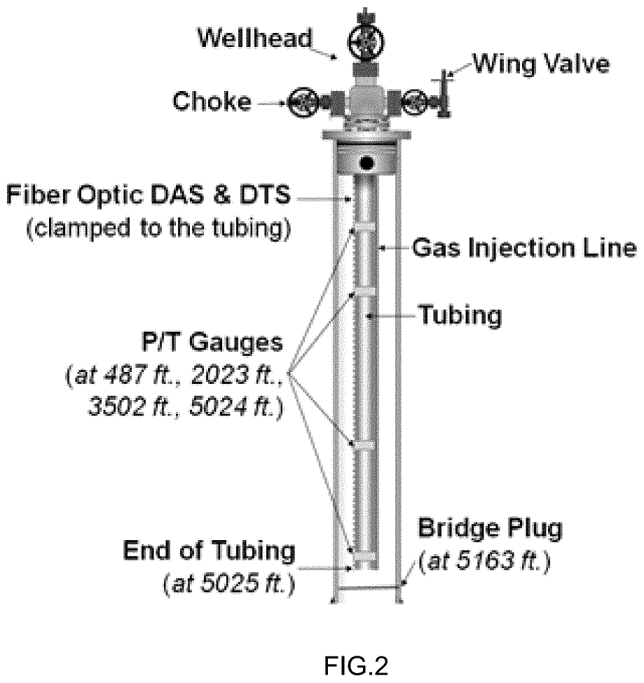

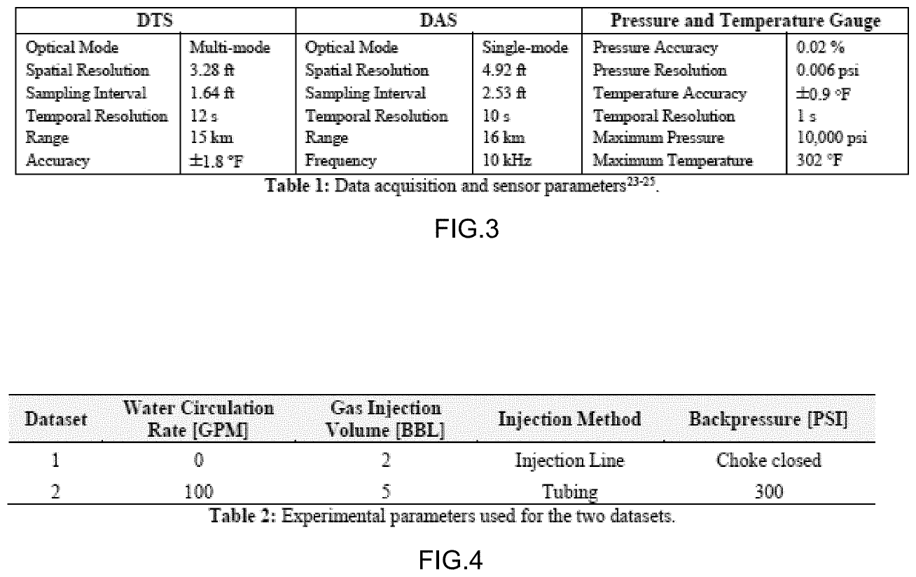

The data analyzed in this study was obtained from two-phase (nitrogen gas and water) flow experiments conducted in a 5163-ft deep test-well located in the Petroleum Engineering Research and Technology Transfer (PERTT) lab facility at LSU. FIG. 2 is a Test-well schematic diagram showing the location of the four downhole gauges and fiber-optic DAS and DTS of the experimental set-up. The wellbore consists of a 9.625 inch (in) diameter casing that is cemented in place, with a 2.875 in diameter concentric tubing to 5025 ft. depth. DAS and DTS fiber cables, along with four downhole pressure and temperature (P/T) gauges are attached to the outside of tubing as shown in FIG. 2. FIG. 3 shows a table that summarizes the data acquisition parameters and sensor specifications.

The DAS was acquired at a frequency of 10 kHz, hence, the maximum frequency that can be measured is 5 kHz based on the Shannon-Nyquist criterion. To obtain the different frequency components of the signal, spectral decomposition is performed on the raw DAS time-domain data by applying the Fast Fourier Transform (FFT). The frequencies are then split up into pre-specified bands consisting of different frequency ranges and then called the frequency band energy (FBE) data. It is preferred to analyze the DAS data in the FBE domain as it provides a simplified snapshot of the acoustic energy over a fixed duration and over different frequency ranges at any given time. FBE data is also much smaller in size as compared to the original time-domain DAS data, making it easier to identify signals of importance and interpret vibration data only on those particular signals, leading to a significant reduction in turnaround time for data interpretation. For this study, seven different frequency bands were analyzed as follows: Band-LF [0-2 Hz], Band-0 [2-5000 Hz], Band-1 [2-10 Hz], Band-2 [10-50 Hz], Band-3 [50-200 Hz], Band-4 [200-500 Hz], and Band-5 [500-1000 Hz]. The acoustic energy contained in frequency bands above 1000 Hz is insignificant in this specific dataset and therefore not analyzed.

### Experimental Procedure and Datasets Analyzed

Two-phase flow experiments using water and nitrogen gas were conducted in the test-well to understand gas water flow dynamics at well-scale conditions. The wellbore was initially filled with water in both the tubing and the casing, and a fixed volume of nitrogen gas (measured in barrels or bbl) was injected either down the tubing or the 0.5 inch diameter gas injection line strapped to the tubing (FIG. 2). The objective of the experiments was to observe and characterize the gas rise in water using the fiber-optic sensors and downhole gauges.

Two different experimental datasets were used in this study to demonstrate the proposed distributed pressure measurement workflow using DTS and DAS. FIG. 4 shows a table that summaries the two datasets in terms of different gas injection volumes, water circulation rates, backpressure, and injection method. The injection sequence is as follows: preconditioning stage—which involves the injection of water into the tubing, through the annulus back to the surface, gas injection stage—which is the injection of nitrogen gas through either the injection line or tubing and the post-circulation or simply water circulation stage—in which water is once more injected to displace the gas in the well. The objective was to demonstrate that the methodology works for different operational conditions. In the first experiment (Dataset-1 in FIG. 4), nitrogen was injected through the gas line and allowed to rise to the surface through the annulus without any water circulation and with the choke closed at the surface, while in the second experiment (Dataset-2 in FIG. 4) the gas injection down the tubing is immediately followed by water injection to push the gas down the tubing and eventually up through the annulus and back to the surface, while a constant backpressure is maintained on the casing at the surface. Both two-phase flow scenarios will create some pressure disturbance that will be recorded by the pressure gauges. One of the objectives of this part of the present disclosure is to model the relationship between the DAS and DTS values to the pressure gauge readings and then use the developed model to predict pressure at different depths. The temperature data read by the downhole gauges was only used for the DTS depth calibration.

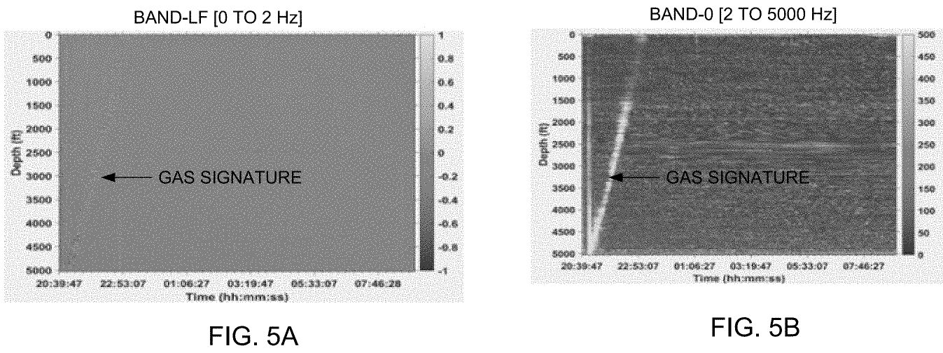

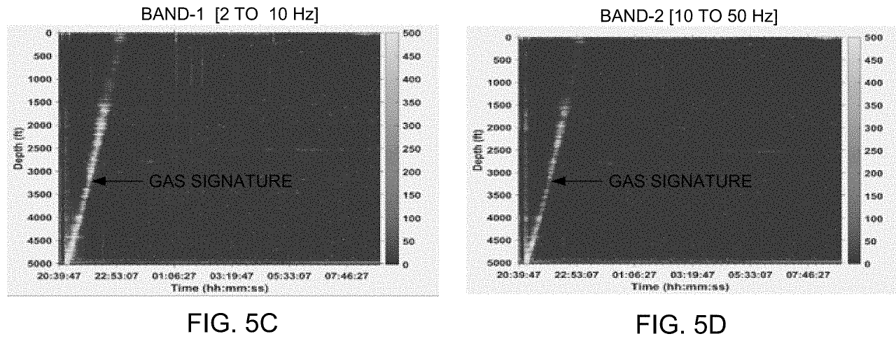

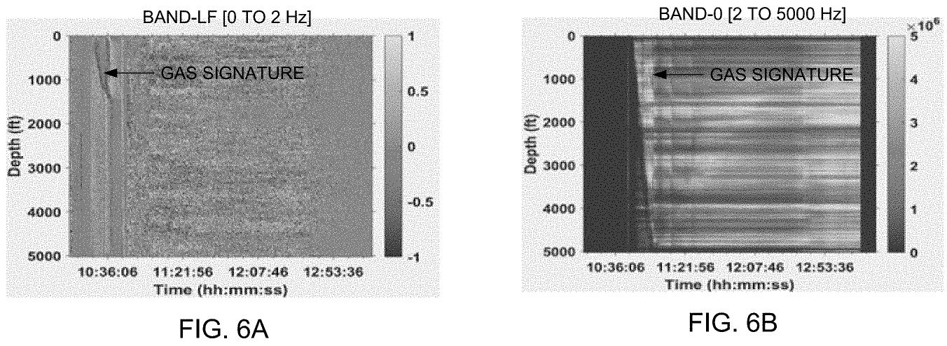

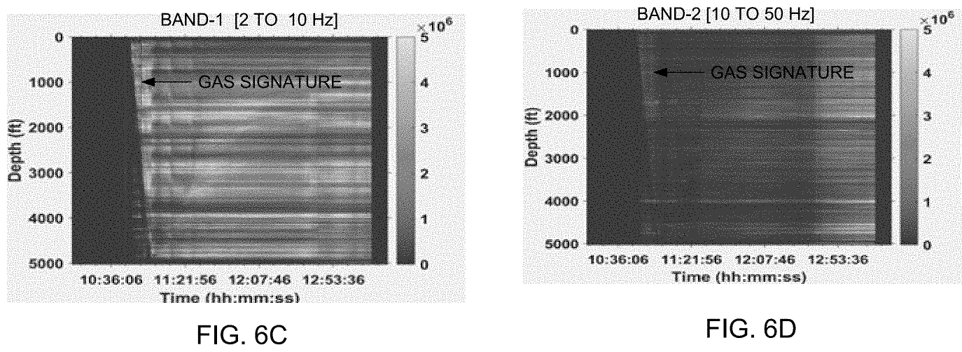

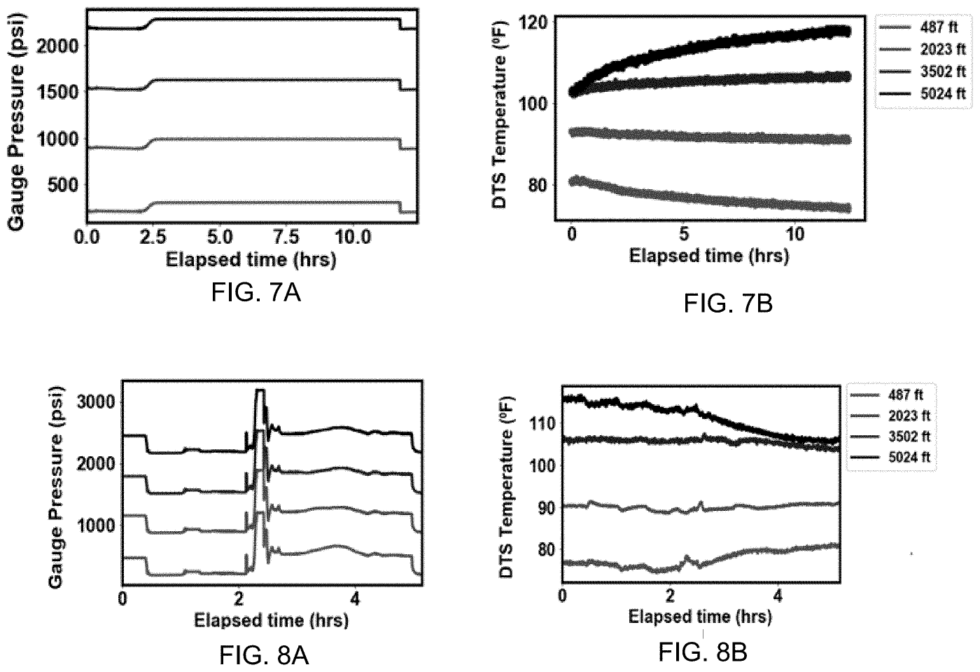

FIGS. 5A-5D and FIGS. 6A-6D show the DAS waterfall plots for Bands-LF, 0, 1, and 2 for Dataset-1 and Dataset-2, respectively, which indicate the gas flow signature in water which is observed more clearly in Dataset-1 (with no water circulation) as compared to Dataset-2 (with water circulation). FIGS. 5A-5D correspond to, respectively, Bands-LF, 0, 1 and 2. Likewise, FIGS. 6A-6D correspond to, respectively, Bands-LF, 0, 1 and 2. A detailed interpretation of the gas signature can be found in the relevant literature. Since the LFDAS data are sensitive to both dynamic strain and temperature changes, Band-LF (0 to 2 Hz) has both positive and negative numbers depending on whether the fiber section is experiencing compressive or tensile strain or heating or cooling phenomenon. FIGS. 7A-7B and FIGS. 8A-8B show the pressure and temperature profiles for Dataset-1 and Dataset-2, respectively, at the four depths where the gauges are installed (487 ft., 2023 ft., 3502 ft., and 5025 ft.). The pressure and temperature data in Dataset-1 (FIGS. 7A and 7B) spanned a period of about 12 hours while that of Dataset-2 (FIGS. 8A and 8B) was about 5 hours. For Dataset-1, the gas rise signature in the annulus was observed at about 2.5 hr elapsed time. The elapsed time is the time difference between any given time and the reference time, where the reference time corresponds to the start of the preconditioning stage described earlier. As expected, the pressures at the different gauges are lower for the top gauge and increase as we go deeper into the well. This is a result of hydrostatic pressure which increases as the depth increases.

For Dataset-1, the effect of the rising gas was observed at about 2.5 hrs while the decrease in pressure at about 11.5 hrs of elapsed time was due to pump shut-off. For Data-set 2 that includes the circulation with water stage, additional pressure effect arises due to turbulence flow. The maximum temperatures at the different gauges also showed an increasing trend down the wellbore as expected from the geothermal gradient. The temperature readings in Dataset-2 are a few degrees lower than Dataset-1 due to the cooling effect from the water circulation (at 100 GPM, see Table 2). In Dataset-2 the pressures were more erratic than those for Dataset-1 due to the flow dynamics effect resulting from water circulation.

### Data Preparation

One of the key steps in the data preparation was to align the downhole sensor data spatially and temporally. As summarized in Table 1 (FIG. 3), DAS, DTS, and the pressure gauges had sampling times of 10 s, 12 s, and 1 s, respectively. While the DTS and DAS produced distributed measurements every 1.64 ft and 2.53 ft, respectively, along the fiber, the pressure gauges measured pressure at only four discrete locations (487 ft., 2023 ft., 3502 ft., and 5025 ft.). The downhole temperature gauge data in the experiment case was only used for depth calibration of the DTS. The first data preparation step was that the three different datasets had to be resampled to ensure that they had the same sampling interval and corresponding timestamps. Therefore, in order to prepare the data points to use in the machine learning model of the present disclosure, the DAS and DTS were time-matched with a criterion that the DTS is matched with the DAS if their timestamps are within ±3 s apart. This is a reasonable criterion since the temperature is not changing rapidly (FIGS. 7A-8B). For some machine learning algorithms, the features or input variables in the dataset need to be transformed via normalization. Normalization ensures fast convergence of the gradient-based learning process, such as neural network models. Min-max scaling was performed on one feature at a time to scale the data (yᵢ) to [−1, 1] using the following equation:

$${y}_{i}^{′} = 2 \frac{{y}_{i} - {y}_{min}}{{y}_{max} - {y}_{min}} - 1 \qquad ( 8 )$$

The chosen machine learning method used in the example embodiment—the random forest machine learning algorithm—is robust and its accuracy remains the same with or without normalization.

### Methodology/Analysis Workflow

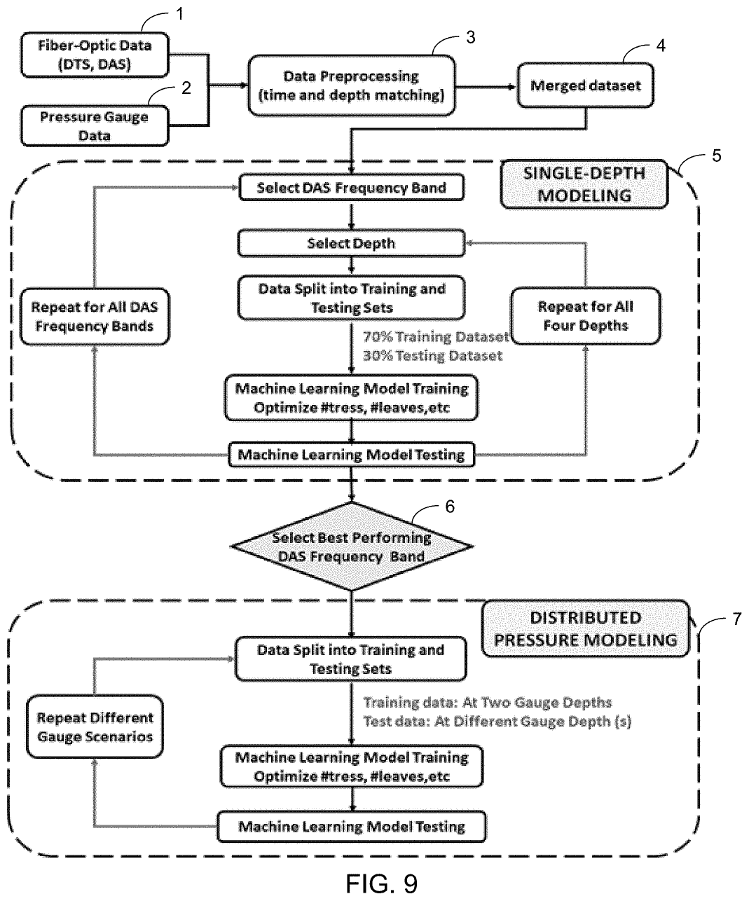

FIG. 9 is a flow diagram depicting the analysis workflow in accordance with a representative embodiment, which can be described as follows:
1) Data Preparation: (Blocks 1-4 in FIG. 9) DTS, DAS, and pressure gauge data is time and depth matched and normalized.
2) Single-Depth Analysis: (Block 5 in FIG. 9) For this experiment and demonstration, the machine learning model is implemented independently at the four gauge depth (487 ft., 2023 ft., 3502 ft., and 5025 ft.). At each depth, the input features for the model are the DAS (one frequency band at a time) and DTS data, while the target output variable is the change in pressure relative to the initial pressure at the first time-step (ΔP). For this example, 70% of the data were randomly selected for model training and the remaining 30% is used for blind testing. The performance is evaluated for each frequency band individually to select the one with the best performance for pressure prediction. This analysis is repeated at all four gauge depths and all seven frequency bands, for the two experimental datasets.
3) DAS Frequency Band Selection: (block 6 in FIG. 9) The best performing frequency band is selected based on the single-depth analysis of block 5 at all four gauge locations, for both datasets. This frequency band is used for the distributed pressure analysis.
4) Distributed Pressure Analysis: (block 7 in FIG. 9) Here the objective is to predict pressure at different depths using the DAS and DTS data. For this example, the machine learning model is trained using data at any two gauge depths and then blind-tested for predicting the pressures at the other gauge depths different from the ones used for training. The input features here are DTS, DAS (only the frequency band selected at block 6), and elapsed time, and the target predicted is the change in pressure (ΔP).

### Random Forest Algorithm

For this experiment, five different machine learning (ML) algorithms were considered for our workflow including random forest, gradient boosting machine (GBM), extreme gradient boosting (XGBoost), support vector regression (SVR), and different architectures of shallow artificial neural network (ANN). Of these, the random forest algorithm was selected as the model to be used in this experiment based on the consistently high performance (high R² and low RMSE) and low computational time when compared with the other algorithms.

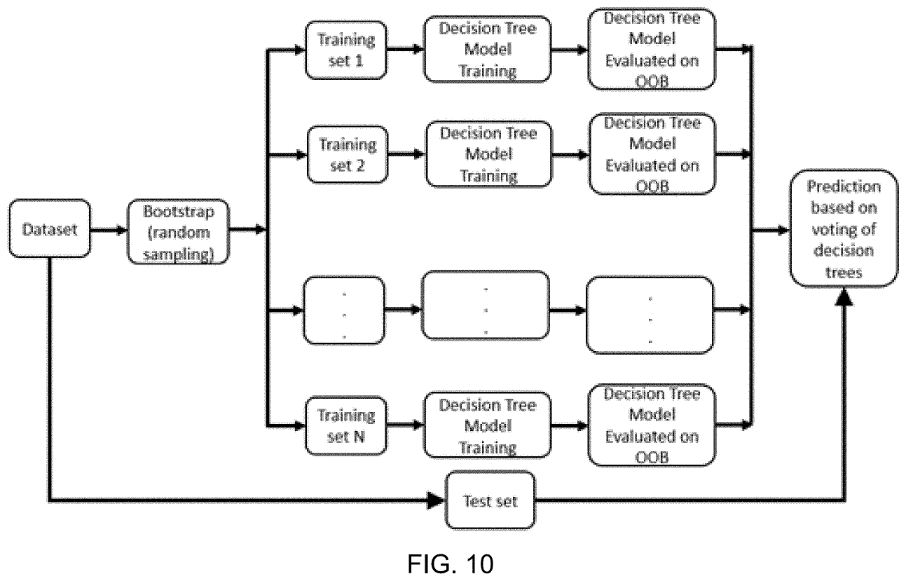

FIG. 10 is a flow diagram of the random forest algorithm, which is an ensemble machine learning technique based on several decision trees. First, the dataset needs to be split into training and testing or evaluation datasets. The training set is then sampled randomly based on the number of decision trees to be trained. Each subset of the training set is further split into training and validation datasets (otherwise known as out-of-bag samples). Each decision tree builds its own model and uses the validation samples for evaluation. The decision tree model is a sequence of rules based on the features (nodes) and splitting criteria. All input variables and possible split points are evaluated and the split points that minimize the cost function (e.g., mean squared error or MSE) across all training samples and validation samples are selected. The cost function can be calculated as:

$$Cost function = \frac{1}{n} {\sum }_{i = 1}^{n} {( {y}_{i} - {\hat{y}}_{i} )}^{2} \qquad ( 9 )$$

where, yᵢ and ŷᵢ are the actual target and predicted target values, respectively, and n is the number of samples. Decision trees have several advantages in that they implicitly perform feature selection, they are not affected by the non-linearity of the predictors and they are relatively easy to interpret. However, they suffer from high variance, that is if we split the data set into two parts at random and then try to train on them, the results could be very different. Hence, in order to build a model with low variance and better accuracy, the ensemble approach is used to combine several decision tree models to obtain a stronger model. The ensemble methods usually involve creating multiple different subsets from the training data, building multiple predictive models, and then combining the predictions. The random forest ML algorithm employed in this work is based on the bootstrap aggregation or bagging for short. Bagging involves bootstrapping the training data to get subsets, learning one model for each set, which is usually run in parallel, and then averaging the model prediction.

The most important hyperparameters that need to be considered in the random forest modeling procedure are as follows:
Number of trees: This is the number of trees that are used in the algorithm. The number of decision trees used in this example was 100 based on a parametric study that showed no appreciable improvement in the performance scores beyond this value.
1. Splitting criteria: The mean square error or MSE was used as the splitting criteria.
2. Stopping criteria: This can be specified by either the maximum depth of each tree or the minimum samples required to split an internal node. If the maximum depth is specified, then the splitting stops after the specified value is reached; otherwise if the nodes are expanded until all leaves are pure or until all leaves contain less than minimum samples for a split. For this experiment, there was no performance improvement beyond a maximum depth of 10.
3. Minimum Sample Split: The minimum samples required to split an internal node is 2 and the minimum number of samples to be in a leaf node is 1.

### Performance Metrics

For the experiment, the coefficient of determination or R-squared (R²) and the root mean squared errors (RMSE) were employed to quantify the performance of the models. These performance metrics are robust enough to give the relative performance across the different scenarios and have been widely used in machine learning model performance assessment. They are calculated as:

$${R}^{2} = \frac{SSR}{SST} = \frac{{\sum }_{i = 1}^{n} {( {\hat{y}}_{i} - {\overline{y}}_{i} )}^{2}}{{\sum }_{i = 1}^{n} {( {y}_{i} - {\overline{y}}_{i} )}^{2}} and RMSE = \sqrt{\frac{1}{n} {\sum }_{i = 1}^{n} {( {y}_{i} - {\hat{y}}_{i} )}^{2}} \qquad ( 10 )$$

where, ŷᵢ is the predicted value, yᵢ is the actual target value, y̅ is the mean of the target values, and n is the number of samples. SSR is the “regression sum of squares” and quantifies how far the estimation is from the target feature mean prediction (based on no relationship with predictors). SST is the “total sum of squares” and quantifies how much the data point varies around their mean.

### Results

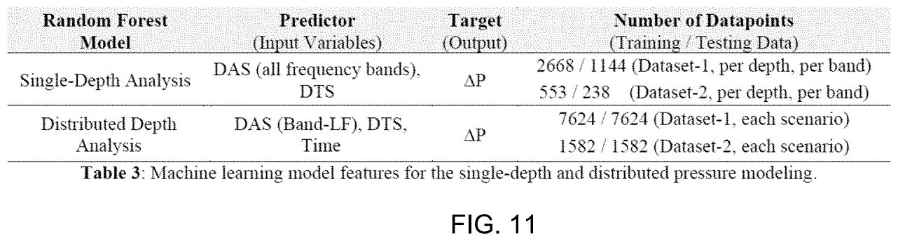

FIG. 11 shows Table 3, which summarizes the input and output features used for the ML models for the single-depth and distributed pressure modeling steps. The results of the exploratory data analysis of the input and output variables will first be presented to identify patterns and data distributions. This is followed by the discussion of results from the random forest models for the single-depth analysis at each gauge depth and the distributed pressure prediction scenarios.

### Descriptive Data Exploration

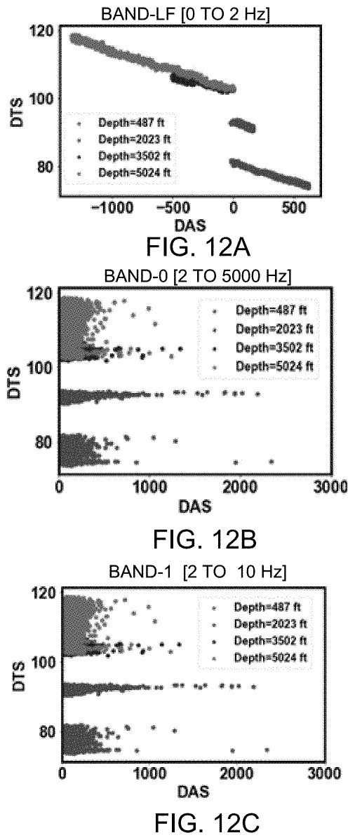

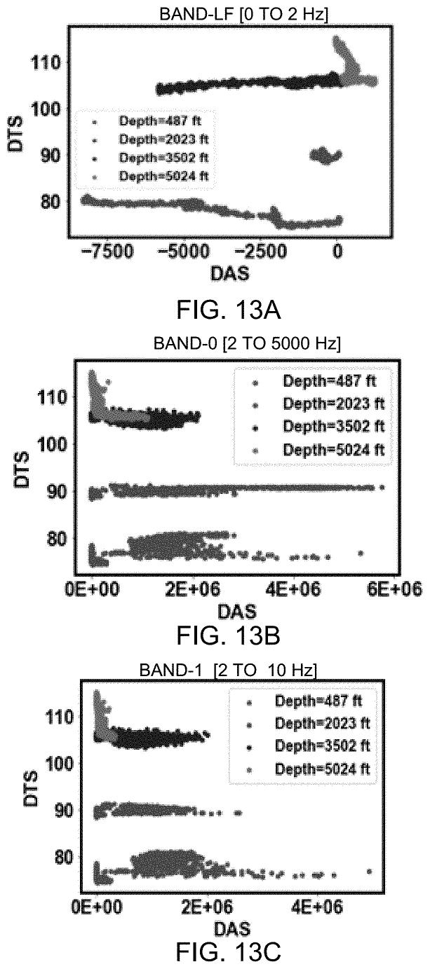

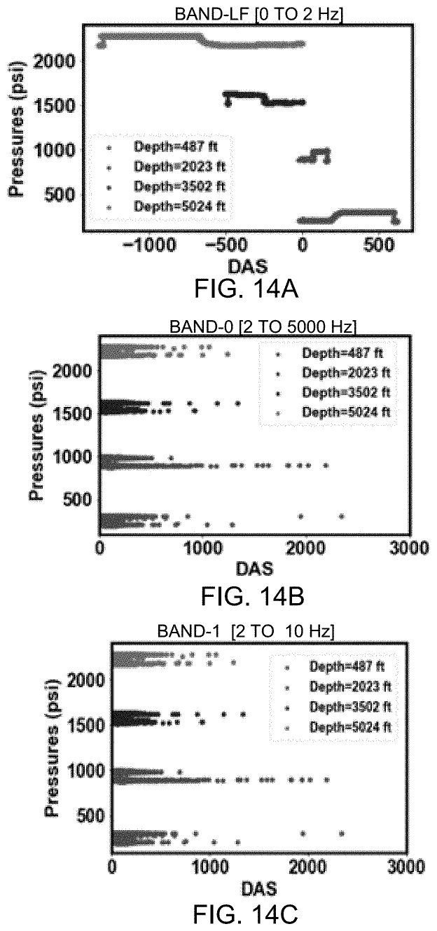

FIGS. 12A-12C and 13A-13C show the cross-plots between DAS and DTS for the DAS frequency Bands-LF, 0, and 1 for Dataset-1 and Dataset-2, respectively. The high-frequency Bands 0 and 1 show a similar DAS-DTS relationship which is distinct from the low-frequency DAS data in Band-LF. For example, FIG. 12A shows a linear DAS-DTS relationship which is not seen for FIGS. 12B and 12C. For the higher frequency bands in both datasets, the relationship between DTS and DAS cannot be clearly explained. FIGS. 14A-14C and 15A-15C show the cross-plots between DAS and pressure at various depths for Datasets-1 and Dataset-2, respectively. Again, the higher frequency DAS Bands 0 and 1 show a similar relationship with pressure, while the DAS Band-LF shows a more distinct trend. The exploratory data analysis demonstrates the unique properties of low-frequency DAS which can be attributed to the sensitivity of DAS to temperature and strain variations at low frequency.

### Single-Depth Predictive Modeling

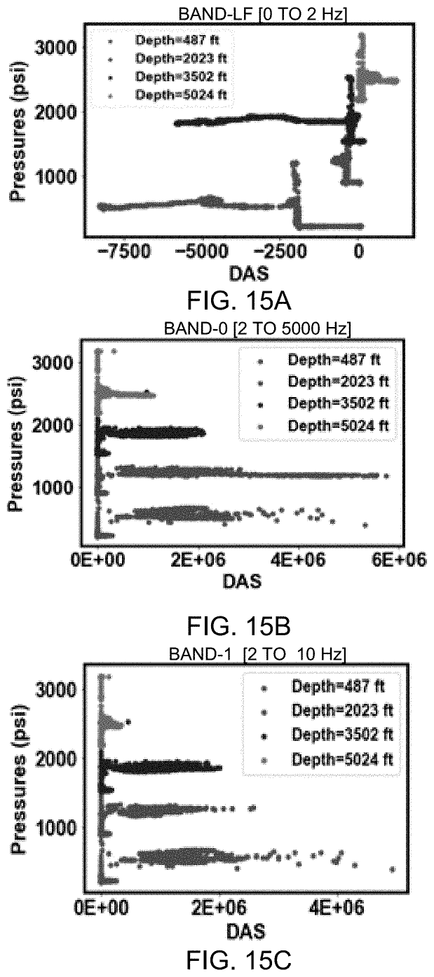

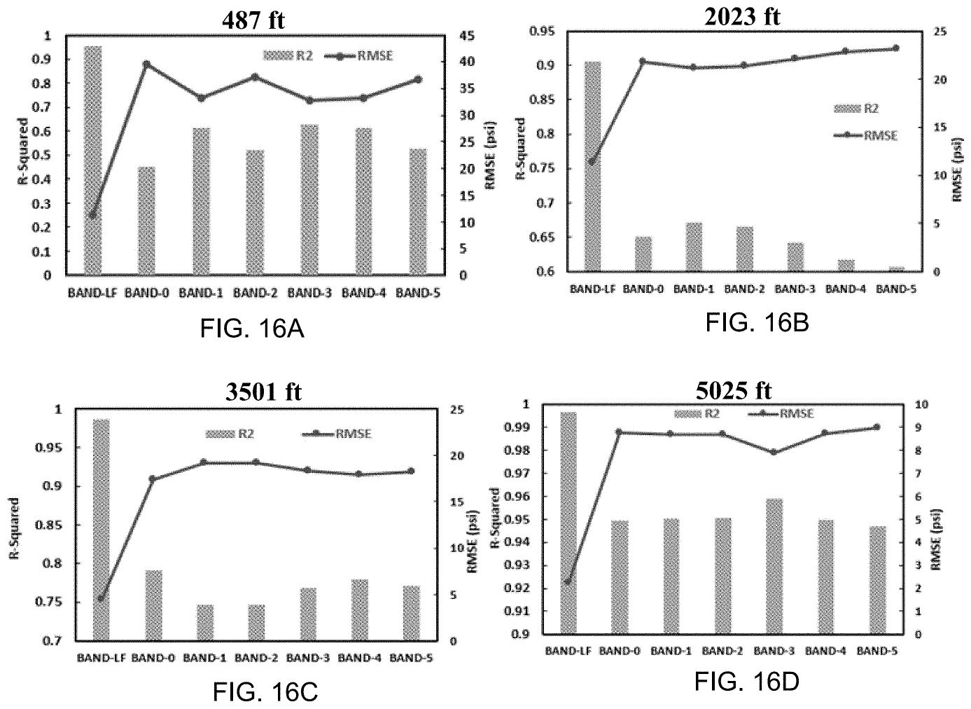

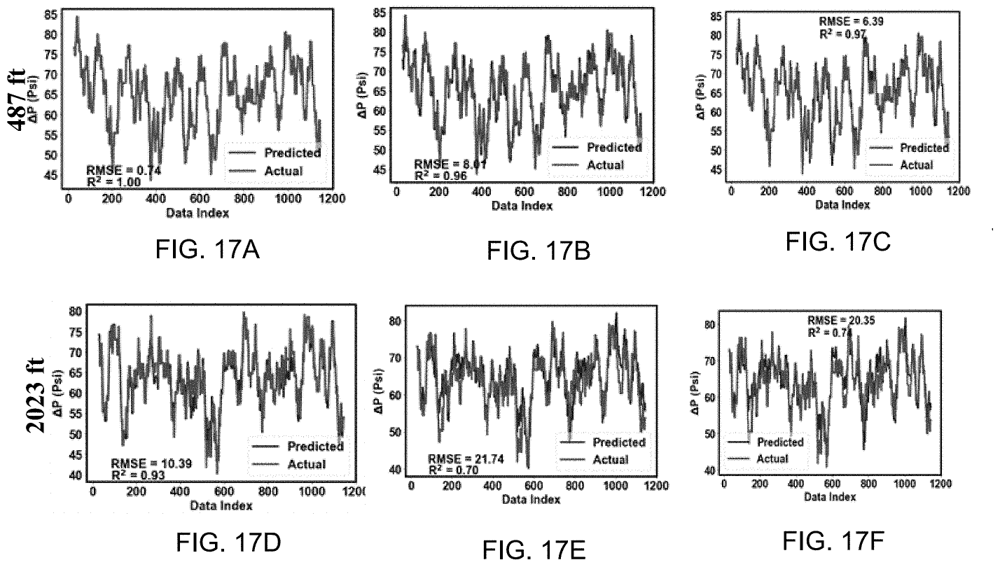

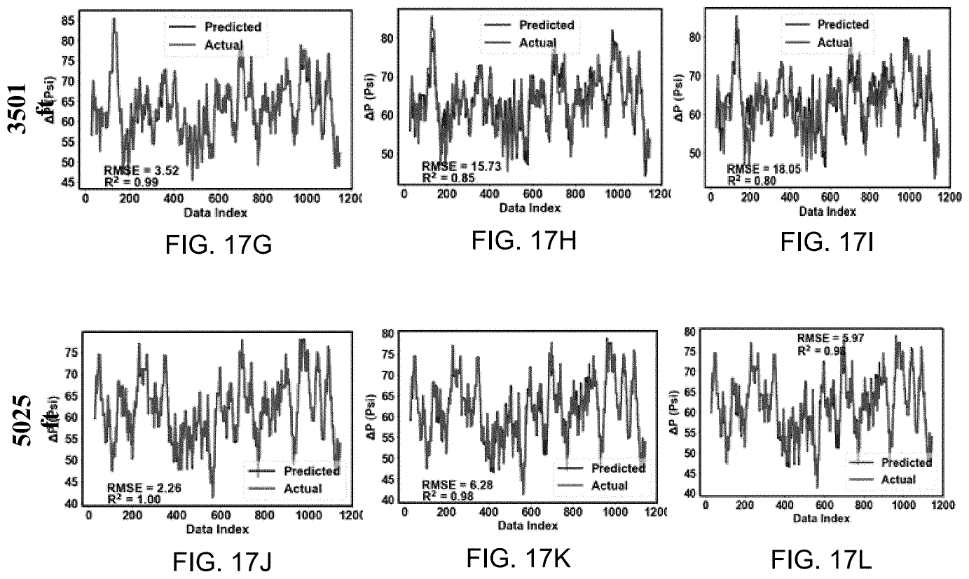

In this section, the results of the single-depth analysis are discussed for both datasets at the four pressure gauge locations. The DAS and DTS were used as the input features while the change in pressure with respect to initial pressure at the first time-step (ΔP) was used as the output variable (FIG. 11, Table 3). FIGS. 16A-16D show the RMSE and R² values for the pressure predictions of the testing sets of Dataset-1 at the four gauge locations for the seven DAS frequency bands. FIGS. 17A-17L show the predicted and the actual pressure profiles for the testing subsample for Dataset-1 for Bands-LF, 0, and 1 at the four gauge locations. The R² of the Band-LF ranged from 0.90 to 0.99 with an average performance across all depths of 0.97, while the average R² value across all depths for the higher frequency bands ranged from 0.81 to 0.83. Similarly, the RMSE values varied between 0.8 to 11.4 psi for the Band-LF and between 8 to 23 psi for the higher frequency bands. The average RMSE across all four depths was 4.7 psi for Band-LF compared to 14.2 psi average RMSE for the higher frequency bands. The results clearly demonstrate that the low-frequency DAS data gives a more accurate prediction for pressure for Dataset-1.

FIGS. 18A-18D show the results from single-depth pressure prediction for Dataset-2 across the four gauge depths for the testing subsample. The R² values for the Band-LF ranged from 0.90 to 0.96 with an average of 0.94 across all depths, while the average R² values for the higher frequency DAS bands ranged from 0.64 to 0.75. Similarly, the RMSE values varied between 6.7 to 11.3 psi for the Band-LF and between 12.3 to 39.5 psi for the higher frequency bands. FIGS. 19A-19L show the predicted and the actual pressure profiles for the testing subsample for Dataset-2 for Bands-LF, 0, and 1 at the four gauge locations. FIGS. 19A-19L compare the predicted and the actual pressure trends for the testing subsample for Dataset-2. Similar to Dataset-1, FIGS. 18A-19L clearly demonstrate that the random forest model using low-frequency DAS as input gives a more accurate prediction of pressure.

### Distributed Pressure Predictive Modeling

The results from the single-depth pressure modeling clearly established that the low-frequency DAS (or Band-LF) gave a consistently better performance compared to the higher frequency DAS bands. Therefore, for the distributed pressure modeling, the input variables of DAS Band-LF, DTS, and elapsed time are used as the input features of the random forest model, and the change in pressure from the original (ΔP) as the output for the random forest model. Training of the model was performed with datasets from any two gauge depths while the resulting model was used to predict pressures at the other two depths. FIGS. 20A-20H and 21A-21H show the predicted versus the actual pressure plots for eight different scenarios, for Dataset-1 and Datset-2, respectively. For example, in FIG. 20A the DTS, DAS and pressure data at 487 ft and 2023 ft were used for training the random forest model and the trained model was used to predict pressures at 3502 ft using the DAS Band-LF and DTS at that depth. The R² values for Dataset-1 (FIGS. 20A-20H) for all eight scenarios were higher than 0.99 with the RMSE ranging between 2.1 to 3.3 psi. Similarly, in Dataset-2 (FIGS. 21A-21H) a strong model performance was observed with R² greater than 0.98 in all cases. For Dataset-2, however, the RMSE was higher (24 psi) compared to Dataset-1, which is likely due to the dynamic effects resulting from water circulation.

### Discussion

Prediction of downhole pressure is crucial for wide-ranging potential applications including the management and evaluation of petroleum, geothermal, and groundwater resources. For oil operators, downhole pressure monitoring supports the determination of well productivity, estimation of flow rates, and sizing of surface and downhole equipment. The industry primarily relies on downhole and surface gauges to meet its pressure data needs, but this often results in a deficiency of crucial data due to the low spatial and temporal resolution achieved from gauges, which only provide measurement at a handful of locations. Distributed pressure measurement simultaneously along the entire wellbore in real-time will give the operators and drillers never-before-seen visibility of the dynamics of fluid flow along the well and may reduce exposure to incidents and improve reservoir management. Although the adoption of DAS and DTS is increasing rapidly, well-scale or field-scale distributed pressure sensing has not been reported using these measurements.

The above study presents the first well-scale application of fiber optics data for pressure prediction. To model the pattern in the data, an ML algorithm was trained and then the developed model was used to predict the pressure data at different depths. In a typical oilfield scenario, surface and downhole pressure gauges are commonly available, which can be used for the model training.

The single-depth analysis showed that the low-frequency DAS (combined with DTS) consistently demonstrated superior capability to predict pressure compared to the higher frequency DAS. A plausible explanation for the better performance shown by the Band-LF (0-2 Hz) is the DAS sensitivity to temperature and strain only in the low-frequency range because the thermal changes typically have a response time much slower than strain changes, and hence will have a much lower frequency content. The pressure response to the fluid compression in turn is related to the longitudinal strain experienced by the fiber through the mechanical properties of the fiber (Poisson's ratio and Young's modulus). The results are consistent with those from some recent studies that have also shown that low-frequency DAS gives a better correlation with pressure. In the well-scale experiments discussed above, the pressures investigated were up to 3200 psi. This study demonstrates that low-frequency DAS combined with DTS can be used for distributed pressure measurement at well-scale.

### Conclusions

This study presents the first well-scale application of distributed fiber-optic data for pressure prediction. In this study, we were able to model the complex relationship that exists between DAS, DTS, and pressures. To model the pattern in the data, we trained a machine-learning algorithm and then used the developed model to predict the dynamic pressure data at different depths. In a typical oilfield scenario, surface and downhole pressure gauges are commonly available, which can be used for model training. The results demonstrate the frequency dependence of the pressure measured by the optical fiber. The low-frequency DAS components (<2 Hz), together with DTS gave more accurate pressure predictions, as compared to the high-frequency DAS components. This study presents a novel application of the low-frequency DAS combined with DTS for distributed pressure measurement.

FIG. 22 illustrates a block diagram of an ML computer system 100 that can be used to acquire DAS and DTS data, to use the acquired DAS and DTS data to train the model and to use the trained model to process acquired DAS and DTS data to perform pressure prediction. A processor 110 performs one or more pressure prediction ML algorithms 120 that train the model to prediction pressure based on DAS and DTS data and then use the trained model to process acquired DAS and DTS data to prediction pressure. The model can be trained and used in the manner described above with reference to the experiments, although ML algorithms other than those described above can be used to train and use the model. The processor 110 is in communication with a non-transitory memory device 130, which can store data and computer instructions, such as those comprising the algorithm(s) 120 in cases where the algorithm(s) 120 are implemented in software and/or firmware.

The system 100 can include an input device 113 for acquiring input data, including DAS and DTS data, to the system 100. For example, the input device 113 can be an optical receiver that converts the optical data from the optical fiber(s) into digital DAS and DTS data that is suitably formatted for processing by the algorithm(s) 120. The acquired DAS and DTS data can be used to train the model, and subsequently, acquired DAS and DTS data can used by the model to perform pressure prediction. A database 150 of DAS and DTS data can also be developed and used to train the model. The system 100 can have other devices typically included in computer systems, such as a display device 111 and a printer 112, for example, for displaying and printing useful information, such as the prediction results.

It should be noted that any or all portions of algorithms described above that are implemented in software and/or firmware being executed by a processor (e.g., processor 110) can be stored in a non-transitory memory device, such as the memory device 130. For any component discussed herein that is implemented in the form of software or firmware, any one of a number of programming languages may be employed. The term “executable” means a program file that is in a form that can ultimately be run by the processor 110. Examples of executable programs may be, for example, a compiled program that can be translated into machine code in a format that can be loaded into a random access portion of the memory device 130 and run by the processor 110, source code that may be expressed in proper format such as object code that is capable of being loaded into a random access portion of the memory device 130 and executed by the processor 110, or source code that may be interpreted by another executable program to generate instructions in a random access portion of the memory device 130 to be executed by the processor 110, etc. An executable program may be stored in any portion or component of the memory device 130 including, for example, random access memory (RAM), read-only memory (ROM), hard drive, solid-state drive, USB flash drive, memory card, optical disc such as compact disc (CD) or digital versatile disc (DVD), floppy disk, magnetic tape, static random access memory (SRAM), dynamic random access memory (DRAM), magnetic random access memory (MRAM), a programmable read-only memory (PROM), an erasable programmable read-only memory (EPROM), an electrically erasable programmable read-only memory (EEPROM), or other like memory device.

It should be emphasized that the above-described embodiments of the present invention are merely possible examples of implementations, merely set forth for a clear understanding of the inventive principles and concepts. Many variations and modifications may be made to the above-described embodiments without departing from the scope of the present disclosure. All such modifications and variations are intended to be included herein within the scope of this disclosure and protected by the following claims.

What is claimed is:

1. A machine learning (ML) system for predicting distributed pressure based at least in part on distributed acoustic sensing (DAS) and distributed temperature sensing (DTS) data, the ML system comprising:
a processor configured to perform a ML pressure prediction algorithm, the ML pressure prediction algorithm performing a process comprising:
using DAS and DTS data acquired from optical signals carried on one or more optical fiber cables to train a model to predict pressure based on the acquired DAS and DTS data;
after the model has been trained, acquiring post-model-training DAS and DTS data from optical signals carried on said one or more optical fiber cables; and
using the model to process the acquired post-model-training DAS and DTS data to predict pressure distributed along said one or more optical fiber cables based at least in part on acquired post-model-training DAS and DTS data; and
a memory device in communication with the processor.

2. The ML system of claim 1, wherein the DAS data used to train the model and the DAS data used by the model to predict pressure is low-frequency (LF) DAS data.

3. The ML system of claim 2, wherein the LF DAS data corresponds to DAS frequency components less than or equal to 2 Hertz (Hz) in frequency.

4. A machine learning (ML) method for predicting distributed pressure based at least in part on distributed acoustic sensing (DAS) and distributed temperature sensing (DTS) data, the ML system comprising:
using DAS and DTS data acquired from optical signals carried on one or more optical fiber cables to training a model to predict pressure based on the acquired DAS and DTS data;
after the model has been trained, acquiring post-model-training DAS and DTS data from optical signals carried on said one or more optical fiber cables; and
using the model to process the acquired post-model-training DAS and DTS data to predict pressure based at least in part on acquired post-model-training DAS and DTS data.

5. The ML method of claim 4, wherein the DAS data used to train the model and the DAS data used by the model to predict pressure is low-frequency (LF) DAS data.

6. The ML method of claim 5, wherein the LF DAS data corresponds to DAS frequency components less than or equal to 2 Hertz (Hz) in frequency.

7. A machine learning (ML) computer program for execution by one or more processors for predicting distributed pressure based at least in part on distributed acoustic sensing (DAS) and distributed temperature sensing (DTS) data, the ML computer program being embodied on a non-transitory computer-readable medium and comprising:
instructions for processing DAS and DTS data acquired corresponding to optical signals carried on one or more optical fiber cables to train a model to predict pressure based on the acquired DAS and DTS data; and
instructions for using the trained model to process DAS and DTS data acquired after the model has been trained to predict pressure based at least in part on acquired post-model-training DAS and DTS data.

8. The ML computer program of claim 7, wherein the DAS data used to train the model and the DAS data used by the model to predict pressure is low-frequency (LF) DAS data.

9. The ML computer program of claim 8, wherein the LF DAS data corresponds to DAS frequency components less than or equal to 2 Hertz (Hz) in frequency.
